(19) United States
(12) Patent Application Publication
(10) Pub. No.: US 2017/0009922 A1
(43) Pub. Date: Jan. 12, 2017

(54) Quick Connector Structure for a Pneumatic Valve

(71) Applicant: Lung-Kuo Hsu, Erlin Township (TW)

(72) Inventor: Lung-Kuo Hsu, Erlin Township (TW)

(21) Appl. No.: 14/795,010

(22) Filed: Jul. 9, 2015

(51) Int. Cl. F16L 37/10

(52) U.S. Cl. CPC F16L 37/105

(57) ABSTRACT

A quick connector structure for a pneumatic valve contains a body, at least one locking unit, and a control set. The body includes at least one inserting hole and an air intake, wherein an airtight washer is fixed between the at least one inserting hole. The body also includes at least one through orifice. The at least one locking unit includes at least one limiting block, each of which has a retaining segment with plural locking teeth and has a defining segment, and between each limiting block and the at least one through orifice is defined a closing ring to close an air flowing gap between each limiting block and the at least one through orifice. The control set is fitted with the body and alternatively presses the defining segment to control each limiting block to move into and to position in the at least one inserting hole.

### BACKGROUND OF THE INVENTION

Field of the Invention

The present invention relates to an air connector for inflating air, and more particularly to a quick air connector structure for a pneumatic valve which is operated easily and quickly

Description of the Prior Art

A conventional air connector is connected with an air inflating apparatus (such as a pump, a pneumatic pump, or a gas cylinder) and a tire to inflate air into the tire from the air inflating apparatus, thus inflating air into the tire.

Conventional air inflating manners contains retaining an air connector with a pneumatic valve by ways of a compression rubber, but the air connector cannot connect with the pneumatic valve tightly and is only used in an air inflating process at a low pressure. In other words, as inflating air at a high pressure, the air connector is sprayed by the high pressure to remove from the pneumatic valve, so a user has to press the air connector downwardly with one hand and to rotate the air connector tightly with the other hand.

The other air inflating manners is to screw male threads with female threads so that the air connector is screwed with the pneumatic valve. However, when screwing the male threads with the female threads at the high pressure, the user has to screw the air connector with the pneumatic valve with one hand and to hold the tire with the other hand, thus having troublesome operation.

As illustrated in FIG. 9, a conventional air connector contains: a body A1 and a control set A2, wherein the body A1 includes a first closing ring A11 disposed on a first end of an outer peripheral side thereof and includes a second closing ring A12 mounted on a second end of the outer peripheral side thereof, and the control set A2 is a hollow cylinder and is fitted on the body A1, wherein an inner wall of the control set A2 retains with the first closing ring A11 and the second closing ring A12 to form an airtight state, and between the control set A2 and the body A1 is defined a gap A3. Nevertheless, the first closing ring A11 has to be parallel to the second closing ring A12 so that the control set A2 slides on the body A1 smoothly, thus causing manufacture difficulty. Furthermore, since the inner wall of the control set A2 retains with the first closing ring A11 and the second closing ring A12 to form the airtight state, the first closing ring A11 and the second closing ring A12 interference the control set A2 as the control set A2 slides on the body A1, thus operating the control set A2 inconveniently. When inflating the air into the tire, the space A3 between the control set A2 and the body A1 is full of high-pressure air to push the control set A2 back to an original position, thereby having difficult operation.

The present invention has arisen to mitigate and/or obviate the afore-described disadvantages.

### SUMMARY OF THE INVENTION

The primary objective of the present invention is to provide a quick connector structure for a pneumatic valve in which plural first locking teeth of a first limiting block engage with or disengage from Presta threads of Presta valve, and plural second locking teeth of a second limiting block engage with or disengage from Schrader threads of Schrader valve, thus obtaining quick assembly, secure connection, and high-pressure inflation.

In addition, a first locking unit includes a closing ring fixed on a smallest area thereof to flow air, so a conventional airtight structure configured between a control set and a body is eliminated to achieve brilliant airtightness and easy operation of the control set.

Another objective of the present invention is to provide a quick connector structure for a pneumatic valve in which the air connector is operated with user's one hand to control the first limiting block and the second limiting block by using the control set, hence the air connector is connected with or is removed from the Schrader valve and the Presta valve easily.

Accordingly, a quick connector structure for a pneumatic valve provided by the present invention is connected with at least one valve to inflate air, and each of the at least one valve includes threads arranged around an outer peripheral side thereof, the air connector contains: a body, at least one locking unit, and a control set.

The body includes at least one inserting hole formed on a first end thereof and an air intake defined on a second end thereof and communicating with the at least one inserting hole, wherein an airtight washer is fixed between the at least one inserting hole, and the body includes at least one through orifice arranged on an outer peripheral side thereof and passing through the at least one inserting hole.

The at least one locking unit includes at least one limiting block matching with and fixed in the at least one through orifice and moving into or out of the at least one through orifice, wherein each of the at least one limiting block has a retaining segment corresponding to each of the at least one inserting hole, and the retaining segment of each limiting block has plural locking teeth, wherein each of the at least one limiting block also has a defining segment extending outwardly from an outer peripheral side thereof, and between each limiting block and the at least one through orifice is defined a closing ring to close an air flowing gap between each limiting block and the at least one through orifice.

The control set is fitted with the body and alternatively presses the defining segment of each limiting block to control each limiting block to move into and position in the at least one inserting hole.

### BRIEF DESCRIPTION OF THE DRAWINGS

FIG. 1 is a perspective view showing the exploded components of a quick connector structure for a pneumatic valve in accordance with a preferred embodiment of the present invention.

FIG. 2 is a perspective view showing the assembly of the quick connector structure for the pneumatic valve in accordance with the preferred embodiment of the present invention.

FIG. 3 is a cross sectional view showing the assembly of the quick connector structure for the pneumatic valve in accordance with the preferred embodiment of the present invention.

FIG. 4 is a cross sectional view showing the operation of a part of the quick connector structure for the pneumatic valve in accordance with the preferred embodiment of the present invention.

FIG. 5 is a cross sectional view showing the operation of the quick connector structure for the pneumatic valve in accordance with the preferred embodiment of the present invention.

FIG. 6 is another cross sectional view showing the operation of the quick connector structure for the pneumatic valve in accordance with the preferred embodiment of the present invention.

FIG. 7 is a cross sectional view showing the assembly of a quick connector structure for the pneumatic valve in accordance with another preferred embodiment of the present invention.

FIG. 8 is a cross sectional view showing the assembly of a quick connector structure for the pneumatic valve in accordance with another preferred embodiment of the present invention.

FIG. 9 is a cross sectional view of a conventional air connector.

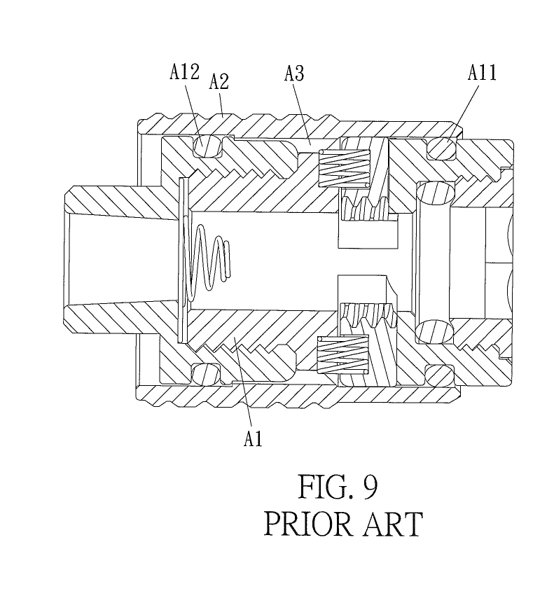

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

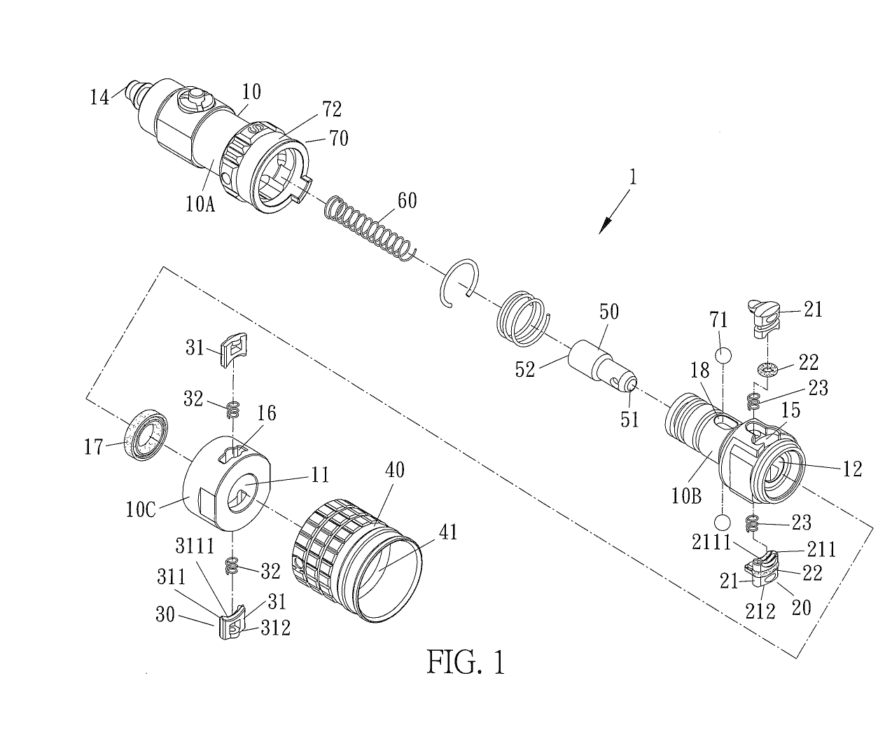

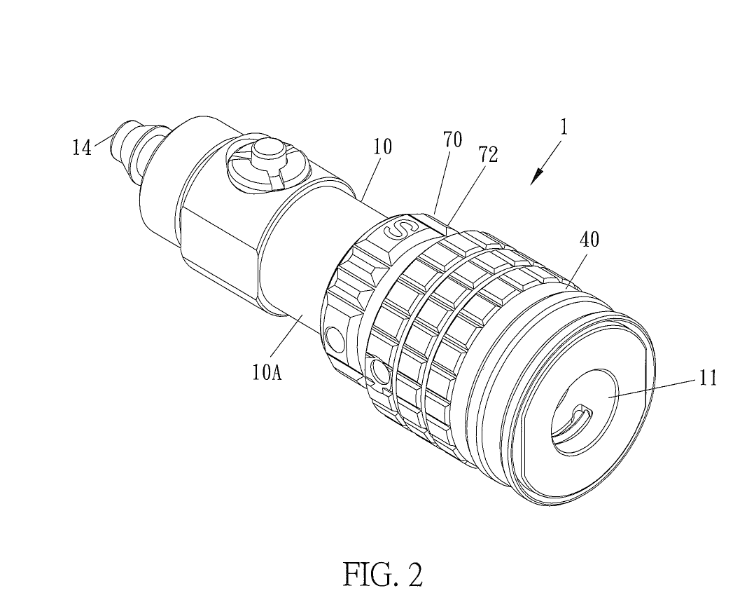

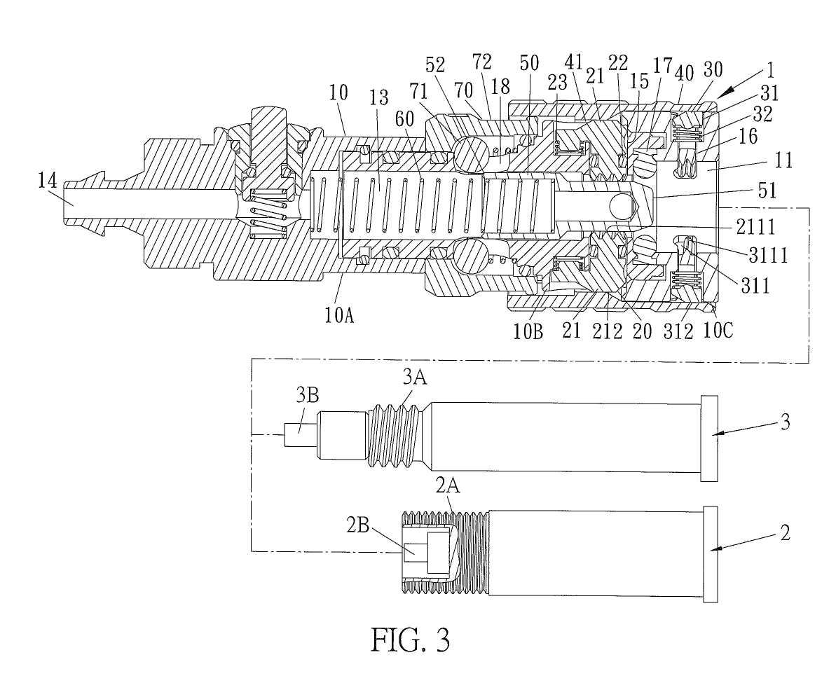

With reference to FIGS. 1 to 3, a quick connector structure of an air connector 1 according to a preferred embodiment of the present invention is connected with a Schrader valve 2 and a Presta valve 3 to inflate air, wherein the Schrader valve 2 includes Schrader threads 2A arranged around an outer peripheral side thereof and includes a Schrader inlet valve 2B disposed in an end portion thereof. The Presta valve 3 includes Presta threads 3A arranged around an outer peripheral side thereof and includes a Presta inlet valve 3B mounted on an end portion thereof. The air connector 1 comprises: a body 10, a first locking unit 20, a second locking unit 30, a control set 40, a movable post 50, a spring 60, and a positioning device 70.

The body 10 is comprised of a first part 10A, a second part 10B, and a third part 10C, wherein the first part 10A is in connection with the second part 10B, and the second part 10B is coupled with the third part 10C. The body 10 includes a Schrader inserting hole 11 formed on a first end thereof and includes a Presta inserting hole 12, an outer diameter of which is less than an outer diameter of the Schrader inserting hole 11, and the Presta inserting hole 12 is spaced a distance away from an inner end of the Schrader inserting hole 11. The body 10 also includes an accommodation groove 13 defined inside the Presta inserting hole 12; an air intake 14 defined on a second end thereof and communicating with the Schrader inserting hole 11, the Presta inserting hole 12, and the accommodation groove 13; at least one first through orifice 15 arranged on an outer peripheral side of the body 10 and passing through the Presta inserting hole 12; at least one second through orifice 16 arranged on the outer peripheral side of the body 10 and passing through the Schrader inserting hole 11; an airtight washer 17 fixed between the Schrader inserting hole 11 and the Presta inserting hole 12; and at least one third through orifice 18 defined on the outer peripheral side of the body 10 and passing through the accommodation groove 13; wherein the air intake 14 is located at the first part 10A, the accommodation groove 13 is defined in the first part 10A and the second part 10B, the Presta inserting hole 12 and the at least one first through orifice 15 are defined in the second part 10B, and the Schrader inserting hole 11 and the at least one second through orifice 16 are arranged in the third part 10C.

The first locking unit 20 includes a first limiting block 21 matching with and fixed in the at least one first through orifice 15 and moving into or out of the at least one first through orifice 15. The first limiting block 21 has a first retaining segment 211 corresponding to the Presta inserting hole 12, and the first retaining segment 211 has plural first locking teeth 2111 for engaging with the Presta threads 3A of the Presta valve 3. The first limiting block 21 also has a first defining segment 212 extending outwardly from an outer peripheral side thereof, wherein between the outer peripheral side of the first limiting block 21 and the at least one first through orifice 15 is defined a closing ring 22 to close an air flowing gap between the first limiting block 21 and the at least one first through orifice 15, and a first pushing spring 23 is fixed between the first limiting block 21 and the body 10 and pushes the first limiting block 21 to move away from the Presta inserting hole 12.

The second locking unit 30 includes a second limiting block 31 matching with and fixed in the at least one second through orifice 16 and moving into or out of the at least one second through orifice 16, the second limiting block 31 has a second retaining segment 311 corresponding to the Schrader inserting hole 11, and the second retaining segment 311 has plural second locking teeth 3111 for engaging with the Schrader threads 2A of the Schrader valve 2. The second limiting block 31 also has a second defining segment 312 extending outwardly from one end thereof, wherein a second pushing spring 32 is fixed between the second limiting block 31 and the body 10 and pushes the second limiting block 31 to move away from the Schrader inserting hole 11.

The control set 40 is disposed on the body 10 and controls the first defining segment 212 of the first limiting block 21 and the second defining segment 312 of the second limiting block 31 so that the plural first locking teeth 2111 of the first retaining segment 211 of the first limiting block 21 and the plural second locking teeth 3111 of the second retaining segment 311 of the second limiting block 21 move in or away from the Presta inserting hole 12 and the Schrader inserting hole 11. The control set 40 is formed in a ring shape and is fitted with the body 10. The control set 40 includes a pressing protrusion 41 to stop a movement of the defining segment 212 of the second limiting block 21, and the control set 40 stops a movement of the second defining segment 312 of the second limiting block 31 by using its inner peripheral side.

The movable post 50 is mounted in and is limited by the accommodation groove 13 of the body 10 to move between the air intake 14 and the Schrader inserting hole 11, and the movable post 50 includes a pressing segment 51 corresponding to the Schrader inserting hole 11 and includes a limitation segment 52 relative to the pressing segment 51, such that the movable post 50 is configured to flow the air, and the pressing segment 51 corresponds to the Schrader inlet valve 2B.

The spring 60 is secured between the accommodation groove 13 of the body 10 and the movable post 50, such that the spring 60 pushes the movable post 50 to move toward the Schrader inserting hole 11.

The positioning device 70 includes at least one steel ball 71 correspond to the at least one third through orifice 18, wherein the at least one steel ball 71 is slidably fixed in the at least one third through hole 18. The positioning device 70 also includes a fitting sleeve 72 fitted with the body 10 and corresponding to the at least one third through orifice 18, and the at least one steel ball 71 is controlled by the fitting sleeve 72 to move into or out of the accommodation groove 13.

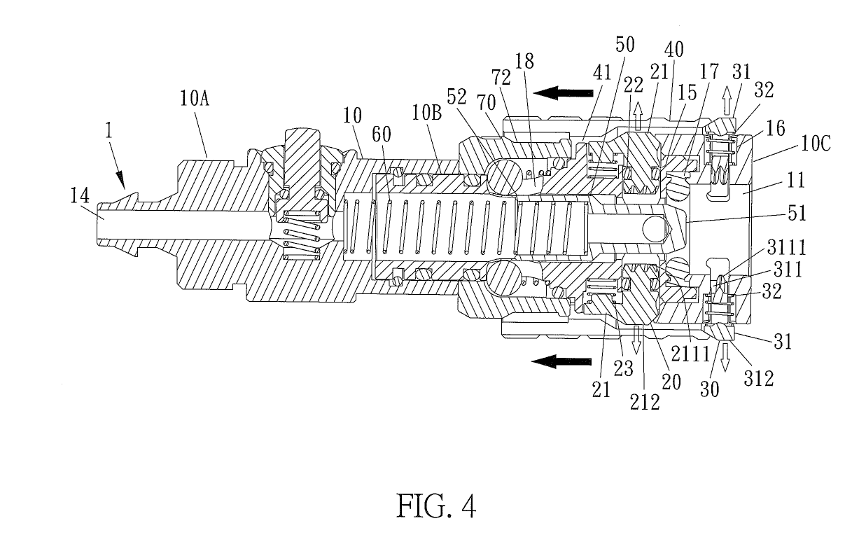

Referring to FIG. 4, when the air connector 1 is connected with the Presta valve 3 and the Schrader valve 2 to inflate the air, the control set 40 slides or rotates so that the pressing protrusion 41 of the control set 40 disengages from the first defining segment 212 of the first limiting block 21 and the second defining segment 312 of the second limiting block 31, and the first limiting block 21 is pushed by the first pushing spring 23 to move away from the Presta inserting hole 12, then the second limiting block 31 is pushed by the second pushing spring 32 to move away from the Schrader inserting hole 11.

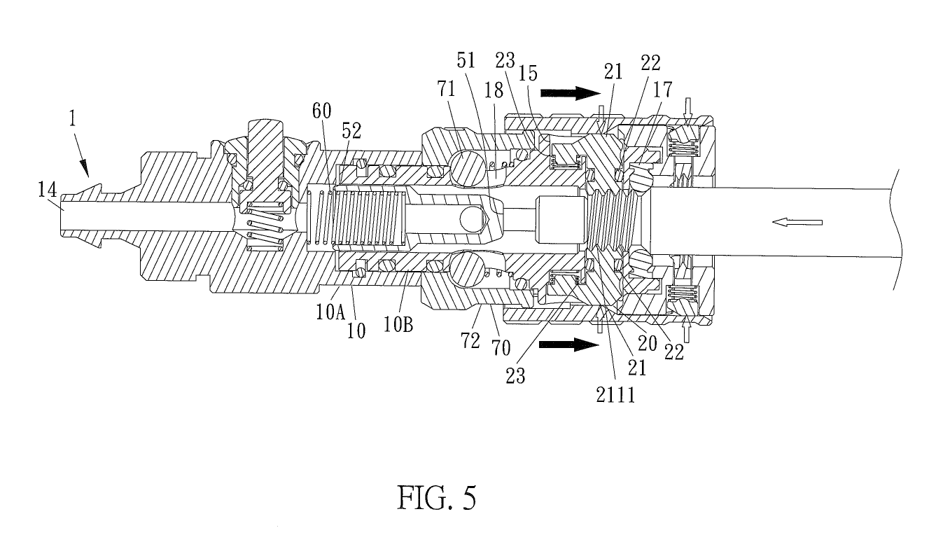

Referring further to FIG. 5, the air connector 1 is fitted with the Schrader valve 2, and the Presta valve 3 is inserted into the Presta inserting hole 12 of the body 10, the Presta threads 3A of the Presta valve 3 align with the plural first locking teeth 2111 of the first limiting block 21, the movable post 50 is pushed by the Presta valve 3 to move toward the accommodation groove 13, and the outer peripheral side of the Presta valve 3 forces the airtight washer 17 to form an airtight state. Thereafter, the control set 40 is slid or rotated so that the pressing protrusion 41 engages with the first defining segment 212 of the first limiting block 21, and the first limiting block 21 is moved inwardly and is positioned, such that the plural first locking teeth 2111 of the first limiting block 21 engage with the Presta threads 3A of the Presta valve 3 to fix the Presta valve 3 securely, and the Presta inlet valve 3B is started by an air pressure, hence the air is inflated into the Presta valve 3 from the air intake 14.

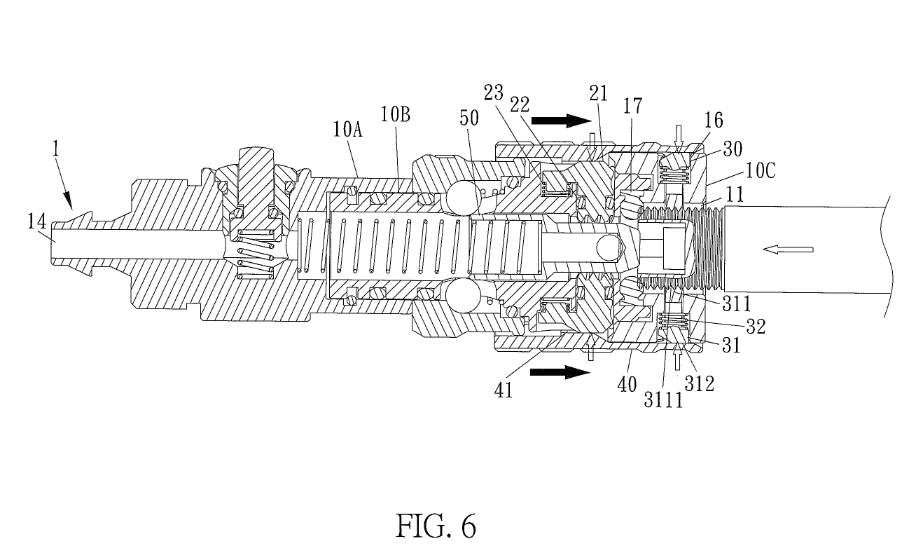

As shown in FIG. 6, the positioning device 70 controls the at least one steel ball 71 to move into the accommodation groove 13 by ways of the fitting sleeve 72, such that the at least one steel ball 71 retains with the limitation segment 52 of the movable post 50, and the movable post 50 does not move toward the accommodation groove 13. Thereafter, the air connector 1 is fitted with the Schrader valve 2, and the Schrader valve 2 is inserted into the Schrader inserting hole 11 of the body 10, the Schrader threads 2A of the Schrader valve 2 align with the plural second locking teeth 3111 of the second limiting block 31, the Schrader valve 2 forces the airtight washer 17 to form the airtight state, and the pressing segment 51 of the movable post 50 starts the Schrader inlet valve 2B, an inner wall of the control set 40 presses the second defining segment 312 of the second limiting block 31 to control the second limiting block 31 to move inwardly so that the plural second locking teeth 3111 of the second limiting block 31 engage with the Schrader threads 2A of the Schrader valve 2 to fix the Schrader valve 2 tightly, thus inflating the air into the Schrader valve 2 from the air intake 14.

When the spring 60 does not operate, the movable post 50 is forced by the air pressure to move toward the Schrader inserting hole 11.

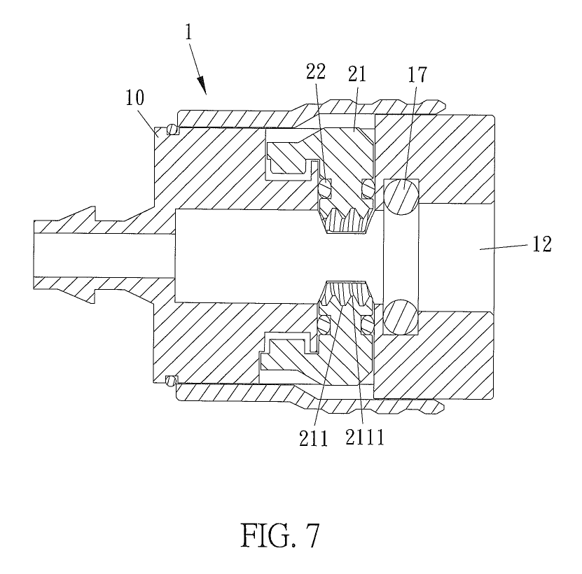

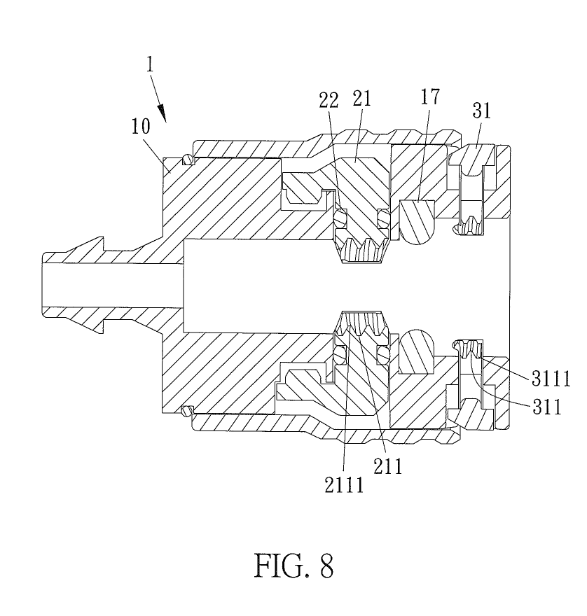

The quick connector structure for a pneumatic valve is also embodied as illustrated in FIGS. 7 and 8.

Thereby, the quick connector structure for a pneumatic valve of the present invention has advantages as follows:

1. The quick connector structure of an air connector 1 is connected with the Schrader valve 2 and the Presta valve 3, wherein the plural first locking teeth 2111 of the first limiting block 21 engage with or disengage from the Presta threads 3A of the Presta valve 3, and the plural second locking teeth 3111 of the second limiting block 31 engage with or disengage from the Schrader threads 2A of the Schrader valve 2, thus obtaining quick assembly, secure connection, and high-pressure inflation. In addition, the first locking unit 20 includes the closing ring 22 fixed on a smallest area thereof to flow the air, so a conventional airtight structure configured between the control set 40 and the body 10 is eliminated in this present invention to achieve brilliant airtightness and easy operation of the control set 40.

2. The air connector 1 is operated with user's one hand to control the first limiting block 21 and the second limiting block 31 by using the control set 40, hence the air connector 1 is connected with or is removed from the Schrader valve 2 and the Presta valve 3 easily.

While we have shown and described various embodiments in accordance with the present invention, it is clear to those skilled in the art that further embodiments may be made without departing from the scope of the present invention.

What is claimed is:

1. A quick connector structure for a pneumatic valve being connected with at least one valve to inflate air, and each of the at least one valve including threads arranged around an outer peripheral side thereof, an air connector comprising:
a body including at least one inserting hole formed on a first end thereof and an air intake defined on a second end thereof and communicating with the at least one inserting hole, wherein an airtight washer is fixed between the at least one inserting hole, and the body includes at least one through orifice arranged on an outer peripheral side thereof and passing through the at least one inserting hole;
at least one locking unit including at least one limiting block matching with and fixed in the at least one through orifice and moving into or out of the at least one through orifice, wherein each of the at least one limiting block has a retaining segment corresponding to each of the at least one inserting hole, and the retaining segment of each limiting block has plural locking teeth, wherein each of the at least one limiting block also has a defining segment extending outwardly from an outer peripheral side thereof, and between each limiting block and the at least one through orifice is defined a closing ring to close an air flowing gap between each limiting block and the at least one through orifice;
a control set fitted with the body and alternatively pressing the defining segment of each limiting block to control each limiting block to move into and to position in the at least one inserting hole.

2. The quick connector structure for a pneumatic valve as claimed in claim 1, wherein the air connector is connected with a Schrader valve and a Presta valve to inflate the air, and the Schrader valve includes Schrader threads arranged around an outer peripheral side thereof and includes a Schrader inlet valve disposed in an end portion thereof, the Presta valve includes Presta threads arranged around an outer peripheral side thereof and includes a Presta inlet valve mounted on an end portion thereof; and the body includes a Schrader inserting hole formed on a first end thereof and includes a Presta inserting hole, an outer diameter of which is less than an outer diameter of the Schrader inserting hole, and the Presta inserting hole is spaced a distance away from an inner end of the Schrader inserting hole; the air intake of the body communicates with the Schrader inserting hole and the Presta inserting hole; the body includes at least one first through orifice arranged on the outer peripheral side thereof and passing through the Presta inserting hole, at least one second through orifice arranged on the outer peripheral side thereof and passing through the Schrader inserting hole, and the airtight washer is fixed between the Schrader inserting hole and the Presta inserting hole.

3. The quick connector structure for a pneumatic valve as claimed in claim 2, wherein the at least one locking unit contains:
a first locking unit including a first limiting block matching with and fixed in the at least one first through orifice and moving into or out of the at least one first through orifice, wherein the first limiting block has a first retaining segment corresponding to the Presta inserting hole, and the first retaining segment has plural first locking teeth for engaging with the Presta threads of the Presta valve, the first limiting block also has a first defining segment extending outwardly from an outer peripheral side thereof, wherein between the outer peripheral side of the first limiting block and the at least one first through orifice is defined a closing ring to close an air flowing gap between the first limiting block and the at least one first through orifice, and a first pushing spring is fixed between the first limiting block and the body and pushes the first limiting block to move away from the Presta inserting hole; and
a second locking unit including a second limiting block matching with and fixed in the at least one second through orifice and moving into or out of the at least one second through orifice, wherein the second limiting block has a second retaining segment corresponding to the Schrader inserting hole, and the second retaining segment has plural second locking teeth for engaging with the Schrader threads of the Schrader valve, the second limiting block also has a second defining segment extending outwardly from one end thereof, and a second pushing spring is fixed between the second limiting block and the body and pushes the second limiting block to move away from the Schrader inserting hole.

4. The quick connector structure for a pneumatic valve as claimed in claim 1, wherein the body also includes an accommodation groove defined inside one of the at least one inserting hole, and the air intake of the body communicates with the at least one inserting hole and the accommodation groove; the air connector further comprises: a movable post mounted in and limited by the accommodation groove of the body to move between the air intake and the one of the at least one inserting hole, and the movable post includes a pressing segment corresponding to the one of the at least one inserting hole and includes a limitation segment relative to the pressing segment, such that the movable post is configured to flow the air.

5. The quick connector structure for a pneumatic valve as claimed in claim 4, wherein the air connector further comprises a spring secured between the accommodation groove of the body and the movable post, such that the spring pushes the movable post to move toward one of the at least one inserting hole.

6. The quick connector structure for a pneumatic valve as claimed in claim 4, wherein the body further includes at least one third through orifice defined on the outer peripheral side thereof and passing through the accommodation groove; and the air connector further comprises a positioning device which includes at least one steel ball corresponding to the at least one third through orifice, wherein the at least one steel ball is slidably fixed in the at least one third through hole, and the positioning device also includes a fitting sleeve fitted with the body and corresponding to the at least one third through orifice, wherein the at least one steel ball is controlled by the fitting sleeve to move into or out of the accommodation groove, and when the at least one steel ball moves into the accommodation groove, it retains with the limitation segment of the movable post to limit the movable post.

7. The quick connector structure for a pneumatic valve as claimed in claim 1, wherein the body is comprised of a first part, a second part, and a third part, wherein the first part is in connection with the second part, and the second part is coupled with the third part, the air intake is located at the first part.

8. The quick connector structure for a pneumatic valve as claimed in claim 2, wherein the body is comprised of a first part, a second part, and a third part, wherein the first part is in connection with the second part, and the second part is coupled with the third part, the air intake is located at the first part.

9. The quick connector structure for a pneumatic valve as claimed in claim 4, wherein the body is comprised of a first part, a second part, and a third part, wherein the first part is in connection with the second part, and the second part is coupled with the third part, the air intake is located at the first part.

10. The quick connector structure for a pneumatic valve as claimed in claim 5, wherein the body is comprised of a first part, a second part, and a third part, wherein the first part is in connection with the second part, and the second part is coupled with the third part, the air intake is located at the first part.
